(19) United States
(12) Patent Application Publication
(10) Pub. No.: US 2016/0364121 A1
(43) Pub. Date: Dec. 15, 2016

(54) METHOD AND ASSOCIATED CIRCUIT FOR ARRANGING WINDOW ON SCREEN

(71) Applicant: MEDIATEK Inc., Hsin-Chu (TW)

(72) Inventors: Shang-Lun Ting, Taipei City (TW); Tzu-Wen Chang, Taipei City (TW)

(21) Appl. No.: 14/735,183

(22) Filed: Jun. 10, 2015

(51) Int. Cl. G06F 3/0484

(52) U.S. Cl. CPC G06F 3/04845; G06F 3/04842

(57) ABSTRACT

The present invention provides a method and a circuit for arranging window(s) on a GUI screen of a device. In an embodiment, the method may include: identifying a layout information associated with the window, with the layout information comprising an aspect condition and/or a direction notification; and, performing a layout determination for the window by: causing an aspect of the window to satisfy the aspect condition; and/or, aligning a direction of the window according to the direction notification, independent of a direction of another window on the screen.

### FIELD OF THE INVENTION

The present invention relates to method and associated circuit for arranging window(s) on a GUI (Graphic User Interface) screen of an electronic device, and more particularly, to method and associated circuit for arranging window(s) by automatically maintaining preferred aspect for each individual window, and/or independently aligning directions of multiple windows for better multi-user experience.

### BACKGROUND OF THE INVENTION

Electronic device with screen for implementing GUI, such as smart mobile phone, tabular computer, notebook computer, hand-held or portable consumer electronic, wearable gadget, navigator, personal digital assistant or health monitor, digital camera, or digital camcorder, etc., has become popular, prevailing and essential in modern society.

Because of evolving computation and processing ability, modern device is allowed to show multiple windows of different (or independent) contents concurrently. For example, the device may execute multiple (software) applications, and accordingly display multiple windows on the screen to visually reflect execution of the multiple applications. In addition, there is an increasingly widespread tendency to equip device with large screen. However, demands on efficient and user-friendly arrangement of multiple windows also emerge.

### SUMMARY OF THE INVENTION

On a screen, a window may be displayed according to several parameters, including a direction and an aspect. For example, a direction of a window may define an upright direction for the window, so content of the window will not be rendered upside down; an aspect of a window may relate to a width and a height of the window, wherein the width may be a dimension perpendicular to the direction of the window, and the height may be a dimension parallel to the direction of the window. Accordingly, a window may be of a horizontal (landscape) aspect if its width is longer than the height, or a vertical (portrait) aspect if its width is shorter than height. In other words, a window may be of a horizontal aspect if a longer one of the two perpendicular sides of the window is perpendicular to the direction of the window, and be of a vertical aspect if the longer one of the two perpendicular sides of the window is parallel to the direction of the window.

An objective of the invention is providing a method for arranging a window (e.g., a[n], FIG. 2 to FIG. 13) on a screen (e.g., 208) of a device, e.g., arranging a second window (e.g., a[n]) along with a first window (e.g., a[n−1]) in a region (e.g., 206) on the screen. The method may include:

identifying a layout information (e.g., s[n], FIG. 2) associated with the window (e.g., the second window), wherein the layout information may include an aspect condition and/or a direction notification; and by the device, performing a layout determination for the window (e.g., the second window) by: causing an aspect of the window (e.g., the second window) to satisfy the aspect condition, and/or, aligning a direction of the window (e.g., the second window) according to the direction notification, independent of a direction of another window (if any; e.g., the first window) on the screen. The region may occupy full viewable (displayable) area of the screen, or just a portion of the viewable area.

In an embodiment, the second window is to be displayed in the region after the first window is already displayed in the region, and the method may further include: adjusting the first window to display the second window. For example (e.g., FIG. 3 to FIG. 6), while the region may previously be filled by the first window, adjusting the first window may include: splitting the region to reduce area of the first window, e.g., splitting the region to form two sub-regions, respectively for displaying the area-reduced first window and the second window.

The aspect condition associated to the window (e.g., the second window) may reflect a relation between the width and the height of the window (e.g., the second window). For example, the aspect condition may include at least one of the following:

the width must be longer than the height; or the width must be shorter than the height; and/or a ratio between the width and the height must equal a predetermined value; or a ratio between the width and the height must be less than an upper bound, and/or, greater than a lower bound.

In response to the aspect condition associated with the second window, the method may further include: if the aspect condition of the second window requires a horizontal aspect with a height of the second window being shorter than a width of the second window, vertically stacking the first window and the second window; e.g., stacking the second window below or above the first window. For example (e.g., FIG. 3), if the preceding first window is of a vertical aspect (with a height of the first window being longer than a width of the first window) and previously fill the region, then the region may be split by a horizontal cut to form two vertically stacked sub-regions, so the subsequent second window may be displayed in one of the sub-regions. Alternatively (e.g., FIG. 6), if the preceding first window is of a horizontal aspect and previously fill the region, the method may further include: changing a direction of the region, so the longer one of the two perpendicular sides of the region, which is originally perpendicular to the direction of the first window, is rotated to align the direction of the first window. The region may then be split by a horizontal cut to provide two vertically stacked sub-regions, so the first window and the second window may be displayed in the two sub-regions.

The method may also include: if the aspect condition of the second window requires a vertical aspect, horizontally lining the first window and the second window; e.g., lining the second window on left or right of the first window. For example (e.g., FIG. 4), if the preceding first window is of a horizontal aspect and previously fill the region, then the region may be split by a vertical cut to form two horizontally side-by-side sub-regions, so the subsequent second window may be displayed in one of the sub-regions. Alternatively (e.g., FIG. 5), if the preceding first window is of a vertical aspect and previously fill the region, the method may further include: changing a direction of the region, so the longer one of the two perpendicular sides of the region, which is originally parallel to the direction of the first window, may be rotated to be perpendicular to the direction of the first window. The region may then be split by a vertical cut to form two horizontally lined sub-regions, so the first window and the second window may be displayed in the two sub-regions.

In an embodiment (e.g., FIG. 3 and FIG. 6), the method may further include:
according to the aspect condition, identifying a longer dimension of the window from two perpendicular sides of the window (e.g., the second window);

and causing the longer dimension of the window (e.g., the second window) to be perpendicular to a longer dimension of the region, with the longer dimension of the region being a longer one of two perpendicular sides of the region.

The method may further include: in response to rotation of the region (e.g., FIG. 8) or an attempt to modify size of the window (e.g., FIG. 7), causing the aspect of the window to keep satisfying the aspect condition. For example (e.g., FIG. 7), the user may try to resize the second window by moving position of the cut which splits the region, but the device may constrain position of the cut in an acceptable range, so the aspect of the second window may still satisfy the aspect condition.

In an embodiment, direction aligning of the method may cause the direction of the second window to differ from the direction of the first window (e.g., FIG. 9 to FIG. 13). Thus, windows of different directions may be displayed for users on different sides of the device, so as to improve multi-user experiences. The direction notification may be triggered by user control (e.g., gestures, FIG. 9 to FIG. 12) or image recognition (e.g., FIG. 13) which may identify locations of the users.

An objective of the invention is providing a method for arranging a window on a screen of a device, e.g., arranging a second window to be displayed along with a first window in a region of the screen. The method may include:

identifying an aspect condition associated with the window (e.g., the second window); and

by the device, performing a layout determination for the window (e.g., the second window) by causing an aspect of the window to satisfy the aspect condition.

An objective of the invention is providing a circuit, e.g., an integrated circuit, a CPU, a baseband processor or an application processor, for arranging a window on a screen of a device, e.g., arranging a second window to be displayed along with a first window in a region of the screen. The circuit (e.g., 200, FIG. 2) may include a layout information module (e.g., 202) and a layout determination module (e.g., 204). The layout information module is capable of identifying a layout information associated with the window (e.g., the second window), wherein the layout information may include an aspect condition and/or a direction notification. The layout determination module is capable of performing a layout determination for the window (e.g., the second window) by: causing an aspect of the window (e.g., the second window) to satisfy the aspect condition; and/or, aligning a direction of the window (e.g., the second window) according to the direction notification, independent of a direction of another window (e.g., the first window) on the screen.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a flowchart according to an embodiment of the invention;

FIG. 2 illustrates a circuit according to an embodiment of the invention;

FIG. 3 to FIG. 12 illustrate exemplary scenarios when the circuit in FIG. 2 applies the flowchart in FIG. 1; and

FIG. 13 illustrates an embodiment based on FIG. 1 and FIG. 2.

### DETAILED DESCRIPTION OF PREFERRED EMBODIMENTS

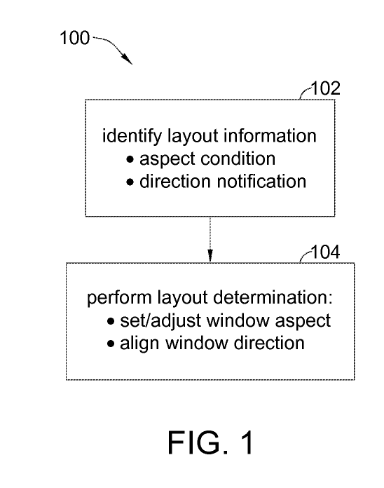

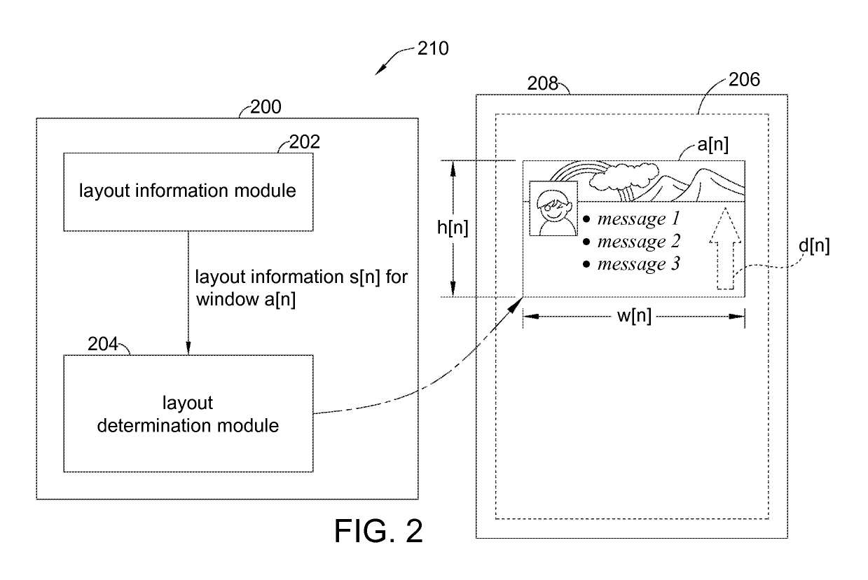

Please refer to FIG. 1 and FIG. 2; FIG. 1 illustrates a flowchart 100 for managing window(s) according to an embodiment of the invention, and FIG. 2 illustrates a circuit 200 for managing window(s) on a GUI screen 208 according to an embodiment of the invention. The circuit 200 may be, for example, an integrated circuit, a CPU, a baseband processor or an application processor of a device 210. For example, the screen 208 may be an LCD (liquid crystal display) panel or a touch sensing screen of the device 210; alternatively, the screen 208 may be a monitor or a television controlled by the device 210 via wireless or wired interconnection in-between.

The circuit 200 in FIG. 2 may apply the flowchart 100 to manage window(s), such as a window a[n], displayed in a region 206 on the screen 208. The region 206 may fill a full viewable (displayable) area of the screen 208, or just a portion of the full viewable area. The circuit 200 may include a layout information module 202 and a layout determination module 204. To manage window(s), e.g., the window a[n], in the region 206, the layout information module 202 may be capable of identifying a layout information s[n] associated with the window a[n], wherein the layout information s[n] may includes an aspect condition and/or a direction notification. The layout determination module 204 may be capable of performing a layout determination for the window a[n] by: causing an aspect of the window a[n] to satisfy the aspect condition included in the layout information s[n]; and/or, aligning a direction d[n] of the window a[n] according to the direction notification included in the layout information s[n], independent of direction(s) of other window(s) in the region 206; e.g., independent of a direction d[n−1] of a window a[n−1] (not shown in FIG. 2).

As shown in FIG. 2, a direction d[n] of the window a[n] may define an upright direction for the window a[n], so content of the window a[n] will not be rendered upside down. An aspect of the window a[n] may relate to a width w[n] and a height h[n] of the window, wherein the width w[n] may be a dimension perpendicular to the direction d[n] of the window a[n], and the height h[n] may be a dimension parallel to the direction d[n] of the window a[n]. Accordingly, the window a[n] may be of a horizontal (landscape) aspect if the width w[n] is longer than the height h[n], or a vertical (portrait) aspect if the width w[n] is shorter than the height h[n].

In an embodiment, the flowchart 100 shown in FIG. 1 may be triggered to start by either one of the following aspect-related events: when a new window a[n] is going to be displayed in the region 206, alone or along with previously exiting window(s), such as a window a[n−1]; e.g., when a software application starts with a new window a[n], when a already running but hidden (showing no window) software application (or background service, e.g., an e-mail client, a schedule reminder, a news receiver, or a status reporter, etc.) pops up to foreground with a new window a[n], or when a already running software (e.g., a web browser) transits from single window to multiple windows for demonstrate different contents (e.g., pages of different web sites); and

when an attempt to modify size of the window a[n] (e.g., a user resizing activity, such as gesture or voice command) is received by the circuit 200; and

when an attempt to rotate the screen 208 or the region 206 (e.g., a user rotating activity, such as gesture or voice command) is received by the circuit 200; and

when the screen 208 or the region 206 is rotated; for example, the device 210 may include a gravity sensor, an accelerometer, a gyroscope, an orientation sensor, a light sensor, and/or a rotation vector sensor (not shown) to sense an upright direction of the screen 208, and accordingly be informed that the screen 208 or the region 206 is rotated. And/or, for example, the device 210 may include one or more cameras with the screen 208 or the region 206 being utilized as viewfinder; when user rotates view of the camera, the device 210 may be informed that the screen 208 or the region 206 is rotated.

Besides the aforementioned aspect-related events, in an embodiment, the flowchart 100 shown in FIG. 1 may also be triggered to start further by a direction-related event happened when the direction notification of a window a[n] is triggered.

Main steps in the flowchart 100 may be described as follows.

Step 102: after the flowchart 100 is triggered to start for arranging window(s), e.g., an n-th window a[n] in the region 206 (FIG. 2), identify layout information associated with the window(s), such as the layout information s[n] of the window a[n], by the layout information module 202 of the circuit 200. For example, the layout information s[n] associated with the window a[n] may include an aspect condition and/or a direction notification.

For example, the aspect condition associated with the window a[n] may require at least one of the following:

the width w[n] of the window a[n] must be longer than the height h[n], e.g., the window a[n] is constrained to be horizontal (of landscape aspect); or

the width w[n] of the window a[n] must be shorter than the height h[n], e.g., the window a[n] is constrained to be vertical (of landscape aspect); and/or

a ratio w[n]/h[n] (or h[n]/w[n]) between the width w[n] and the height h[n] of the window a[n] must equal a predetermined value AspectRatio[n] (or equal to one of a plurality predetermined values AspectRatio[n,1] to AspectRatio[n,K]); or

the ratio w[n]/h[n] (or h[n]/w[n]) of the window a[n] must be less than an upper bound AspectRatio_Max[n], and/or, greater than a lower bound AspectRatio_Min[n].

The aspect condition associated with a window may be utilized to reflect a default, preferred, desirable, expected and/or ideal relation between width and height of the window, e.g., default aspect(s), user-preferred aspect(s), and/or aspect(s) which will facilitate correct, better or optimum performance for content rendering and/or displaying. For example, some horizontal-constrained applications may only support windows of horizontal aspect (e.g., with horizontal width longer than vertical height), and fail to work properly if using windows of vertical aspect (e.g., with horizontal width shorter than vertical height). To effectively avoid application failure due to incorrect window aspect, the aspect conditions may be utilized to record correct aspect(s) allowing proper functioning of aspect-constrained applications. Some applications may not be constrained to specific aspect, but user (or device manufacturer, interface designer, application developer, etc.) may have preferred aspect for windows of these applications, and the aspect conditions may also be utilized to record the preferred aspect(s) associated with these applications.

In an embodiment, the layout information module 202 (FIG. 2) may include an interface (not shown) capable of accessing a database (not shown) maintained in a volatile or non-volatile memory (not shown) embedded in the circuit 200 or external to the circuit 200, wherein the database may record multiple aspect conditions respectively associated with different applications, so when the flowchart 100 is triggered to start, e.g., when an application starts with a new window or needs to open a new window in the region 206, or when an attempt to resize or rotate existed window(s) in the region 206 is received, the layout information module 202 may look up the database in step 102 to access the aspect condition associated with the new window, and/or, if necessary, access the aspect condition(s) associated with the window(s) already existed in the region 206.

On the other hand, the direction notification associated with the window a[n] may direct how to align the direction d[n] of the window a[n]. The direction notification may be triggered by user control, or image recognition which may identify locations of users. For example, the screen 208 may be a touch sensing screen capable of sensing gesture(s) of user(s), the device 210 or the circuit 200 may identify location of the sensed gesture and compare the sensed gesture with predetermined directing gesture(s), and trigger a direction notification associated with a window if the sensed gesture locates in the window and matches a predetermined directing gesture. And/or, the device 210 may include a camera (not shown) capable of capturing still or animated image(s) of user, and may identify location of users by image recognition (e.g., face recognition), so as to trigger a direction notification according to, e.g., at which side the user(s) is (are) recognized.

Step 104: by the layout determination module 204 of the circuit 200, perform a layout determination for the window(s), e.g., the window a[n], by: causing an aspect of the window a[n] to satisfy the aspect condition associated with the window a[n], and/or, aligning the direction d[n] of the window a[n] according to the direction notification associated with the window a[n], independent of direction(s) of other window(s) (if any) in the region 206 on the screen 208.

The flowchart 100 may include more or fewer steps. The circuit 200 may include more or fewer modules. The modules shown in FIG. 2 may be implemented by hardware, or a processor executing related software or firmware codes.

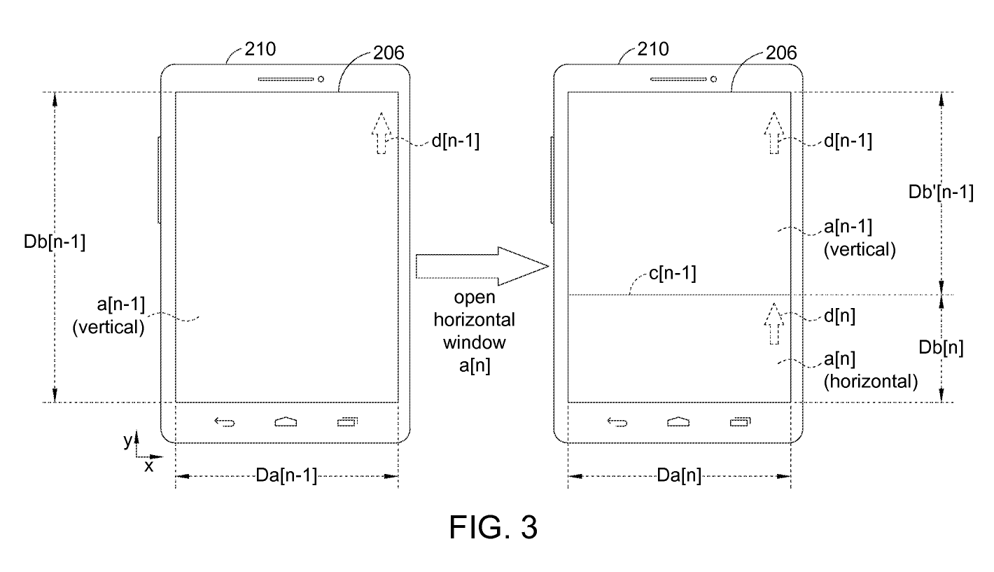

Continuing the exemplary embodiment shown in FIG. 1 and FIG. 2, please refer to FIG. 3 to FIG. 8 illustrating different exemplary window arrangement scenarios when the circuit 200 applies the flowchart 100 to arrange windows in the region 206. In the scenarios shown in FIG. 3 to FIG. 8, the device 210 may be a smart mobile phone, for example.

In the scenario shown in FIG. 3, the region 206 originally displays an existed window a[n−1], and the flowchart 100 is triggered to start when a new window a[n] is going to be displayed also in the region 206. The window a[n−1] may be a vertical window; for example, the window a[n−1] may be associated with a vertical-constrained aspect condition which requires the window a[n−1] to be of vertical aspect. That is, with a direction d[n−1] of the window a[n−1] being parallel to y-axis, the vertical-constrained aspect condition may demand that a side dimension Db[n−1] (as a height parallel to the direction d[n−1]) of the window a[n−1] is longer than a side dimension Da[n−1] (as a width perpendicular to the direction d[n−1]) of the window a[n−1].

Different from the window a[n−1], in the exemplary scenario shown in FIG. 3, the window a[n] to be displayed along with the existed window a[n−1] may be a horizontal one; e.g., the window a[n] may be associated with a horizontal-constrained aspect condition, which requires a width of the window a[n] (a dimension perpendicular to a direction d[n] of the window a[n]) to be longer than a height of the window a[n] (a dimension parallel to the direction d[n]).

When the window a[n] is to be opened by the flowchart 100 (FIG. 1), the layout information module 202 of the circuit 200 (FIG. 2) may identify the horizontal-constrained aspect condition associated with the window a[n] (and the vertical-constrained aspect condition associated with the window a[n−1], if necessary) in step 102. Then, in step 104, the layout determination module 204 may adjust size of the window a[n−1] to display the window a[n], such that an aspect of the newly opened window a[n] may satisfy the associated horizontal-constrained aspect condition, and an updated (adjusted) aspect of the window a[n−1] may keep satisfying the associated vertical-constrained aspect condition.

For example, as shown in FIG. 3, while the region 206 may previously be filled by the window a[n−1], the layout determination module 204 may cause the region 206 to be split, so as to reduce area of the window a[n−1] and therefore create room for the window a[n]; for example, the region 206 may be split by a horizontal cut c[n−1] along x-axis to form two vertically stacked sub-regions, respectively for displaying the area-reduced window a[n−1] and the window a[n]. The layout of the vertically stacked sub-regions may be helpful to satisfy both the vertical-constrained aspect condition of the window a[n−1] and the horizontal-constrained aspect condition of the window a[n]. Though the window a[n] is opened below the window a[n−1] in the example shown in FIG. 3, the window a[n] may be opened above the window a[n−1].

After execution of step 104, the direction d[n] may be parallel to the direction d[n−1], the updated existed window a[n−1] may be of side dimensions Db′[n−1] and Da[n−1] respectively as an updated height and a width, with the dimension Db′[n−1] adjusted to be shorter than the original dimension Db[n−1] but still being longer than the dimension Da[n], so as to comply with the vertical-constrained aspect condition of the window a[n−1]; the window a[n] may be of side dimensions Db[n] and Da[n] respectively as a height and a width, with the former set to be shorter than the latter to satisfy the horizontal-constrained aspect condition of the window a[n]. Note that the dimensions Db[n] and Db′[n−1] may be of different lengths.

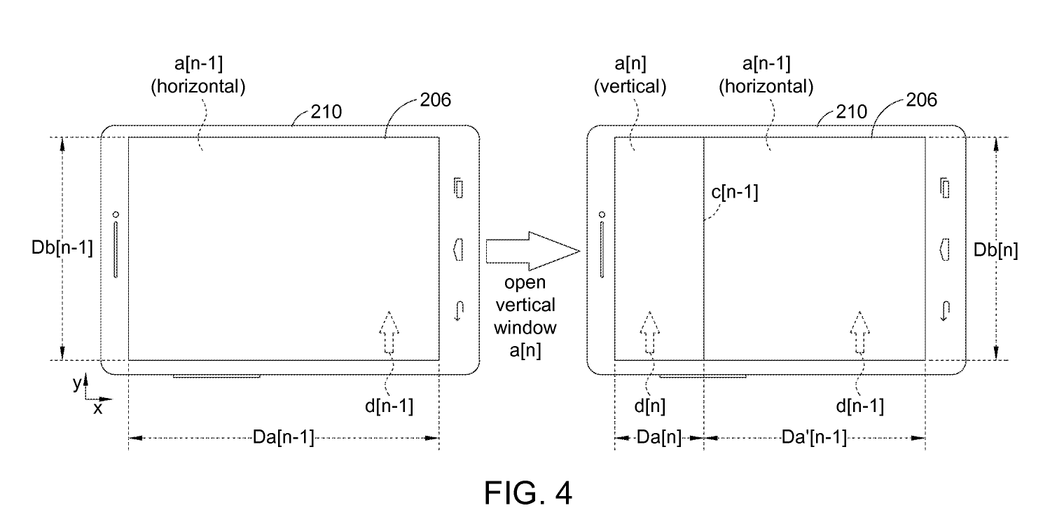

In the scenario shown in FIG. 4, a window a[n] of a vertical aspect, e.g., of a vertical-constrained aspect condition, is to be opened in the region 206 by the flowchart 100, along with an existed window a[n−1] of a horizontal aspect, e.g., of a horizontal-constrained aspect condition. As the layout information module 202 (FIG. 2) identifies that the windows a[n−1] and a[n] are respectively associated with horizontal-constrained and vertical-constrained aspect conditions in step 102 (FIG. 1), the layout determination module 204 may automatically adopt a layout which horizontally lines the windows a[n−1] and a[n] side by side, as shown in FIG. 4, because such layout may be helpful for satisfying both the horizontal-constrained aspect condition of the window a[n−1] and the vertical-constrained aspect condition of the window a[n].

As shown in FIG. 4, the window a[n−1] may originally be of dimensions Da[n−1] and Db[n−1] respectively as a width and a height referring to a direction d[n−1] along y-axis, with the dimensions Da[n−1] longer than Db[n−1] for horizontal aspect. After the circuit 200 applies the flowchart 100, the region 206 may be split to two by a vertical cut c[n−1]; the window a[n−1] may be of updated dimensions Da′[n−1] and Db[n] respectively as a width and a height referring to the direction d[n−1], and the window a[n] may be of dimensions Da[n] and Db[n] respectively as a width and a height referring to a direction d[n] along y-axis; wherein the dimension Da′[n−1] may be shorter than the dimension Da[n−1], but remain to be longer than the dimension Db[n], so the window a[n−1] may maintain horizontal aspect before and after opening of the window a[n]; and, the dimension Da[n] may be shorter than the dimension Db[n], such that the window a[n] may be of vertical aspect as required. Though the window a[n] is at left side of the window a[n−1] in the example of FIG. 4, the window a[n] may be placed at right side of the window a[n−1].

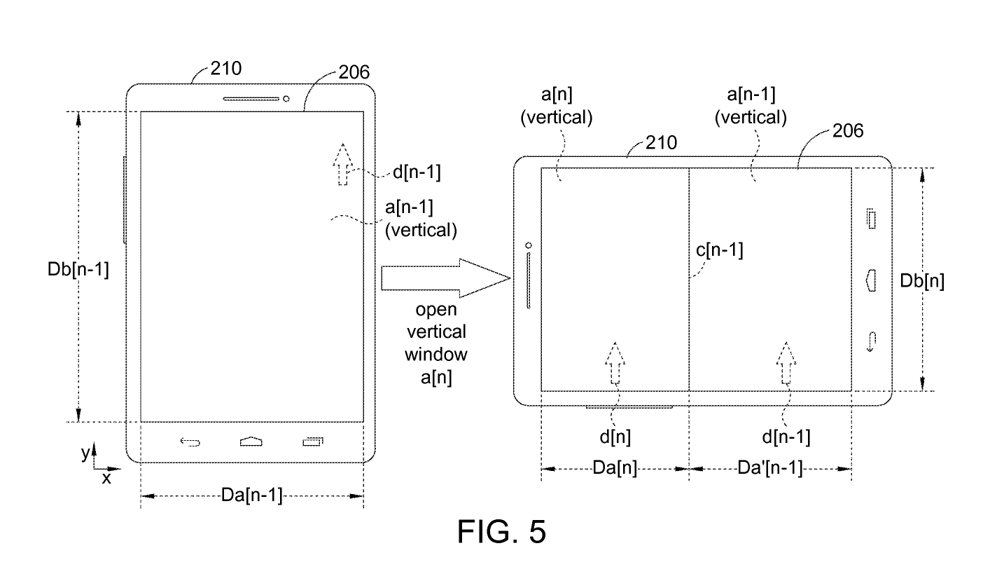

In the exemplary scenario shown in FIG. 5, a window a[n] of a vertical aspect, e.g., of a vertical-constrained aspect condition, is to be opened in the region 206 by the flowchart 100, along with an existed window a[n−1] of a vertical aspect, e.g., of a vertical-constrained aspect condition. As the layout information module 202 (FIG. 2) identifies that the windows a[n−1] and a[n] are associated with vertical-constrained aspect conditions in step 102 (FIG. 1), the layout determination module 204 may automatically adopt a layout which horizontally lines the windows a[n−1] and a[n] side by side along a longer one of the dimensions Db[n−1] and Da[n−1], as shown in FIG. 5, because such layout may be advantageous to satisfy the vertical-constrained aspect conditions of the windows a[n−1] and a[n]. Note that the region 206 may be rotated for the horizontal lining layout; the dimension Db[n−1], as the longer one of two perpendicular sides of the region 206, is originally parallel to y-axis, but may be rotated to align x-axis, so as to be split for displaying both the windows a[n−1] and a[n].

As shown in FIG. 5, the window a[n−1] may originally be of dimensions Da[n−1] and Db[n−1] respectively as a width and a height referring to a direction d[n−1] along y-axis, with the dimensions Da[n−1] shorter than Db[n−1] for vertical aspect. After the circuit 200 applies the flowchart 100, the region 206 may be split to two by a vertical cut c[n−1]; the window a[n−1] may be of updated dimensions Da′[n−1] and Db[n] respectively as a width and a height referring to the direction d[n−1], and the window a[n] may be of dimensions Da[n] and Db[n] respectively as a width and a height referring to a direction d[n] along y-axis, wherein the dimension Da′[n−1] may be shorter than the dimension Db[n−1], also be shorter than the dimension Db[n], so the window a[n−1] may maintain vertical aspect before and after opening of the window a[n]; the dimension Da[n] may be shorter than the dimension Db[n], such that the window a[n] may be of vertical aspect as required. Though the window a[n] is at left side of the window a[n−1] in the example of FIG. 5, the window a[n] may be placed at right side of the window a[n−1].

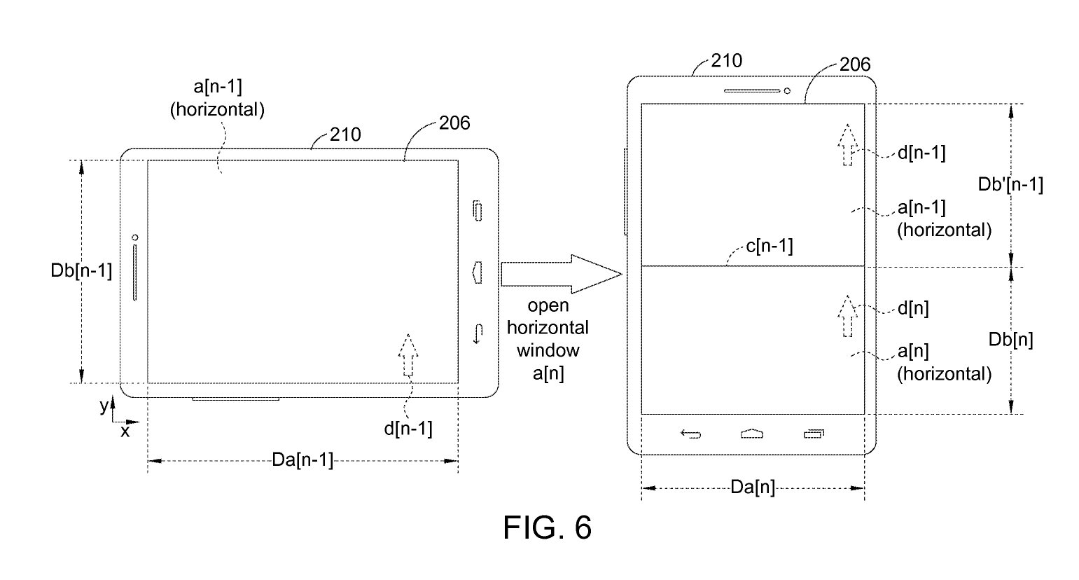

In the exemplary scenario shown in FIG. 6, a window a[n] of a horizontal aspect, e.g., of a horizontal-constrained aspect condition, is to be opened in the region 206 by the flowchart 100, along with an existed window a[n−1] of a horizontal aspect, e.g., of a horizontal-constrained aspect condition. As the layout information module 202 (FIG. 2) identifies that the windows a[n−1] and a[n] are associated with horizontal-constrained aspect conditions in step 102 (FIG. 1), the layout determination module 204 may automatically adopt a layout which vertically stack the windows a[n−1] and a[n] along the longer one of the dimensions Da[n−1] and Db[n−1], as shown in FIG. 6, because such layout may be beneficial to satisfy the horizontal-constrained aspect conditions of the windows a[n−1] and a[n]. Note that the region 206 may be rotated for the vertically stacking layout; the dimension Da[n−1], as the longer one of two perpendicular sides of the region 206, is originally perpendicular to y-axis, but may be rotated to align y-axis, so as to be split for displaying both the windows a[n−1] and a[n].

As shown in FIG. 6, the window a[n−1] may originally be of dimensions Da[n−1] and Db[n−1] respectively as a width and a height referring to a direction d[n−1] along y-axis, with the dimensions Da[n−1] longer than Db[n−1] for horizontal aspect. After the circuit 200 applies the flowchart 100, the region 206 may be split to two by a horizontal cut c[n−1]; the window a[n−1] may be of updated dimensions Da[n] and Db′[n−1] respectively as a width and a height referring to a direction d[n−1] along y-axis, and the window a[n] may be of dimensions Da[n] and Db[n] respectively as a width and a height referring to a direction d[n] along y-axis, wherein the dimension Db′[n−1] may be shorter than the dimension Da[n−1], and also be shorter than the dimension Da[n], so the window a[n−1] may maintain horizontal aspect before and after opening of the window a[n]; the dimension Da[n] may be longer than the dimension Db[n], such that the window a[n] may be of horizontal aspect as required. Though the window a[n] is at bottom side of the window a[n−1] in the example of FIG. 6, the window a[n] may be placed at top side of the window a[n−1].

As shown in the scenarios of FIG. 4 and FIG. 5, if the window a[n] to be opened is of vertical aspect (e.g., of vertical-constrained aspect condition), the layout determination module 204 may horizontally line the windows a[n−1] and a[n]. As shown in FIG. 5, if the existed window a[n−1] is of vertical aspect, the layout determination module 204 may further change direction of the region 206; e.g., cause the longer one of the two perpendicular sides of the region 206 to be perpendicular to the direction d[n−1] or d[n].

As shown in the scenarios of FIG. 3 and FIG. 6, if the window a[n] to be opened is of horizontal aspect (e.g., of horizontal-constrained aspect condition), the layout determination module 204 may vertically stack the windows a[n−1] and a[n]. As shown in FIG. 6, if the existed window a[n−1] is of horizontal aspect, the layout determination module 204 may further change direction of the region 206; e.g., cause the longer one of the two perpendicular sides of the region 206 to align the direction d[n−1] or d[n].

As illustrated by FIG. 3 to FIG. 6, arranging windows in step 104 may be equivalent to:

according to the aspect condition of the window a[n], identifying a longer dimension of the window a[n] from two perpendicular sides of the window a[n]; and

causing the longer dimension of the window a[n] to be perpendicular to a longer dimension of the region 206, with the longer dimension of the region 206 being a longer one of two perpendicular sides of the region 206.

For example, in FIG. 3 and FIG. 6, after execution of the step 104, the longer side of the window a[n] (e.g., the dimension Da[n] perpendicular to y-axis) and the longer side of the region 206 (e.g., the side parallel to y-axis) may be arranged to be perpendicular; similarly, in FIG. 4 and FIG. 5, after execution of the step 104, the longer side of the window a[n] (e.g., the dimension Db[n] parallel to y-axis) and the longer side of the region 206 (e.g., the side perpendicular to y-axis) may be arranged to be perpendicular.

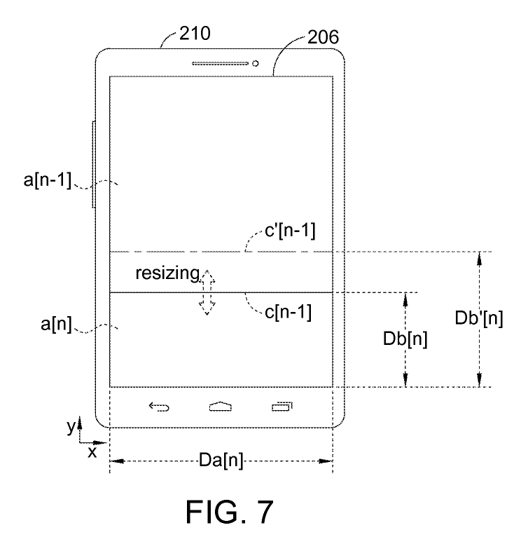

In the exemplary scenario shown in FIG. 7, while the region 206 has been split for the windows a[n−1] and a[n] by a cut c[n−1], the flowchart 100 may be triggered to start when the circuit 200 receives an attempt (originated from user, for example) to resize the window by, e.g., relocating the cut c[n−1]. For example, assuming that the window a[n] is associated with an aspect condition, the layout information module 202 may identify the aspect condition of the window a[n] in step 102; according to the aspect condition, the layout determination module 204 may automatically determine an acceptable range for side(s) of the window a[n], e.g., an acceptable range for the cut c[n−1] which forms one side of the window a[n], such that the aspect condition may remain satisfied if side(s) of the window is/are kept within the acceptable range after resizing. For example, in the scenario shown in FIG. 7, a bound of an acceptable range for the cut c[n−1] may be reflected by an acceptable cut c′[n−1], wherein the aspect condition of the window a[n] may remain satisfied if the cut c[n−1] is below the acceptable cut c′[n−1]; e.g., both the dimension combinations (Da[n], Db[n]) and (Da[n], Db′[n]) may satisfy the aspect condition of the window a[n]. On the other hand, the aspect condition may be violated if the cut c[n−1] is above the acceptable cut c′[n−1].

As the layout determination module 204 determines the acceptable range, the layout determination module 204 may automatically keep the side(s) within the acceptable range during resizing, by, e.g., ignoring attempts to relocate the side(s) beyond the acceptable range. For example, if user wants to move the cut c[n−1] above the acceptable cut c′[n−1], the layout determination module 204 may force the cut c[n−1] to stay at the position of the acceptable cut c′[n−1]. That is, in response to an attempt to change size of the window a[n], the circuit 200 may automatically cause the aspect of the window a[n] to keep satisfying the aspect condition of the window a[n] by, e.g., forcing side(s) of the window a[n] to stay at closest bound(s) of the acceptable range if the side(s) is/are relocated beyond the acceptable range. Although the example shown in FIG. 7 is related to vertically stacked windows, the same aspect-keeping principle may apply to horizontally lined windows.

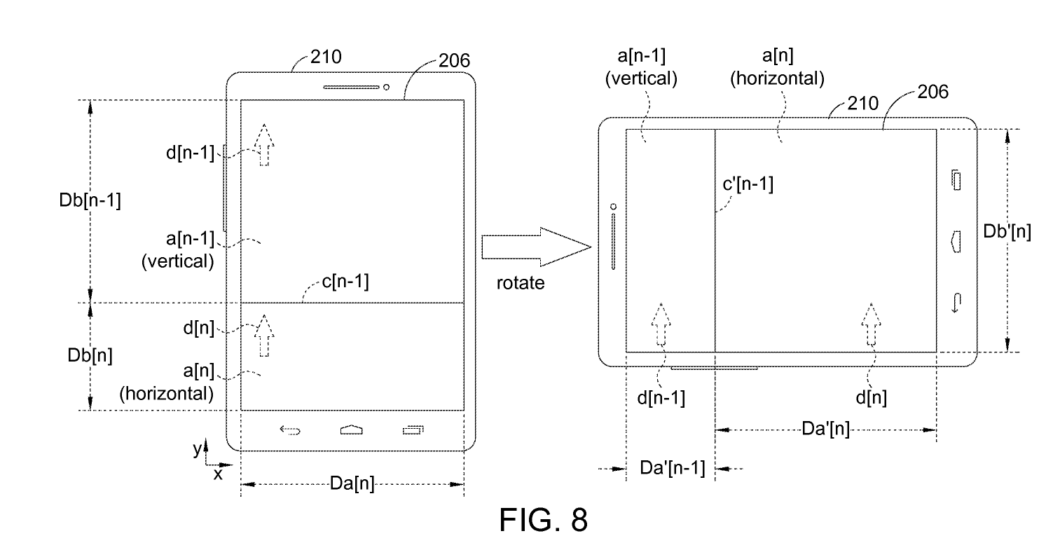

In the exemplary scenario shown in FIG. 8, the circuit 200 may be triggered to execute the flowchart 100 when the screen 208 (and therefore the region 206) is rotated. As shown in FIG. 8, the region 206 may originally have the longer one of its two perpendicular sides parallel to a direction d[n−1] of the window a[n−1] or a direction d[n] of the window a[n], but may be rotated so the longer side of the region 206 becomes perpendicular to the direction d[n−1] or d[n]. When the region 206 is rotated and the flowchart 200 is triggered to start, the layout information module 202 may identify the aspect conditions associated with the windows a[n−1] and a[n] in step 102; according to the aspect conditions, the layout determination module 204 in step 104 may automatically determine an updated layout which may cause the aspect of each window to keep satisfying the aspect condition of each window.

For example, in the example shown in FIG. 8, the windows a[n−1] and a[n] may respectively be associated with a vertical-constrained aspect condition and a horizontally-constrained aspect condition, and originally be vertically stacked with the region 206 split by a horizontal cut c[n−1]. As the region 206 is rotated, the windows a[n−1] and a[n] may be rearranged to horizontally line up side by side, with the region 206 split by a vertical cut c′[n−1]. The horizontally lining layout may be helpful to satisfy the vertical-constrained aspect condition of the window a[n−1] and the horizontally-constrained aspect condition of the window a[n] after the region 206 is rotated. That is, for the window a[n−1], the dimension combination (Da[n], Db[n−1]) before rotation and the dimension combination (Da′[n−1], Db′[n]) after rotation may both satisfy the vertical-constrained aspect condition of the window a[n−1]; similarly, for the window a[n], the dimension combination (Da[n], Db[n]) before rotation and the dimension combination (Da′[n], Db′[n]) after rotation may both satisfy the horizontal-constrained aspect condition of the window a[n]. Though the window a[n−1] is placed at left side of the region 206 after rotation, the window a[n−1] may also be placed at right side of the region 206 after rotation. Though FIG. 8 only illustrates rotation of a vertically stacking layout in context a vertical-constrained aspect condition and a horizontal-constrained aspect condition, rotation of other kinds of layouts in other combinations of aspect conditions may also be automatically adapted by the circuit 200.

Though the exemplary layouts shown in FIG. 3 to FIG. 8 relate to two windows, the layout determination module 204 may arrange layout for more windows based on the principles demonstrated by FIG. 3 to FIG. 8.

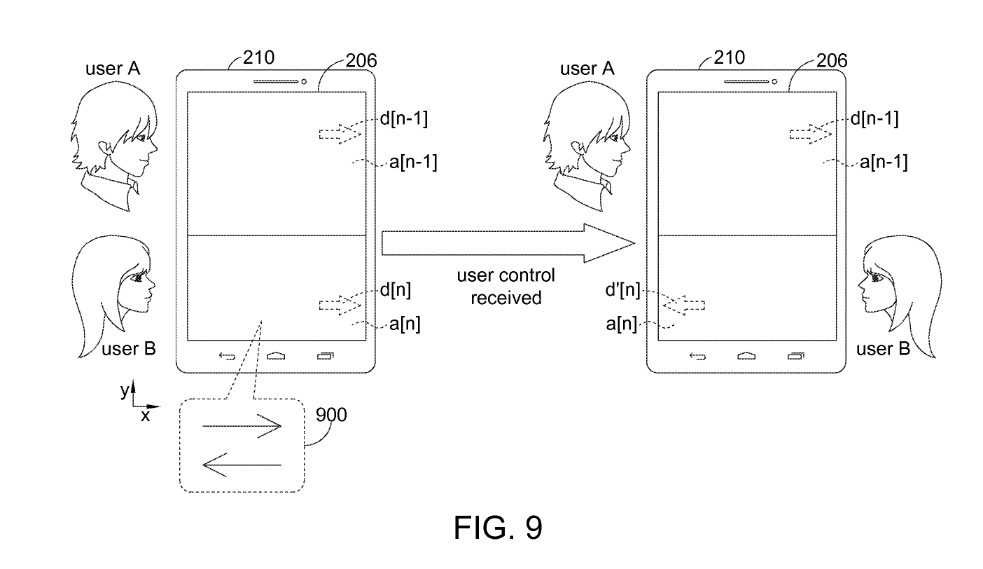

The flowchart 100 may also be executed when a direction notification associated with a window is triggered. Continuing the embodiment shown in FIG. 1 and FIG. 2, please refer to FIG. 9 to FIG. 12 illustrating exemplary scenarios when the circuit 200 executes the flowchart 100 in response to direction notification. In the examples of FIG. 9 to FIG. 12, there may be multiple windows, such as the windows a[n−1] and a[n], displayed in the region 206.

As shown in FIG. 9, originally, directions d[n−1] and d[n] of the windows a[n−1] and a[n] may point along positive x-axis. When a direction notification associated with the window a[n] is triggered by a user control, the flowchart 100 may be triggered to start; in step 102, the layout information module 202 may identify the direction notification, so in step 104 the layout determination module 204 may align direction of the window a[n] according to the direction notification, independent of direction(s) of other window(s), such as the direction d[n−1] of the window a[n−1]. For example, the screen 208 (FIG. 2) displaying the region 206 may be a touch sensing screen capable of sensing gesture(s) of user(s), the device 210 (or the circuit 200) may identify location of the sensed gesture and compare the sensed gesture with predetermined directing gesture(s), and trigger the direction notification associated with the window a[n] if the sensed gesture locates in the window a[n] and matches an exemplary predetermined directing gesture 900. The directing gesture 900 may reflect a transition between positive and negative directions. Accordingly, in step 104, the layout determination module 204 may align the window a[n] along an updated direction d′[n], which may be opposite to the original direction d[n], e.g., point along negative x-axis; meanwhile, the direction d[n−1] of the window a[n−1] may remain unchanged. That is, the layout determination module 204 may cause the direction d′[n] of the window a[n] to differ from the direction d[n−1] of the window a[n−1] in step 104.

The independent direction layout over multiple windows may benefit sharing of the same display region 206 over multiple users. In the example shown in FIG. 9, two users A and B may originally be at the same side (e.g., the left side) of the device 210 to respectively view the windows a[n−1] and a[n], but the user B may use a gesture, which matches the gesture 900, to transit direction of the window a[n] from the direction d[n] to d′[n], so the user B may move to the opposite side (e.g., the right side) of the device 210 to view the window a[n] with more comfort.

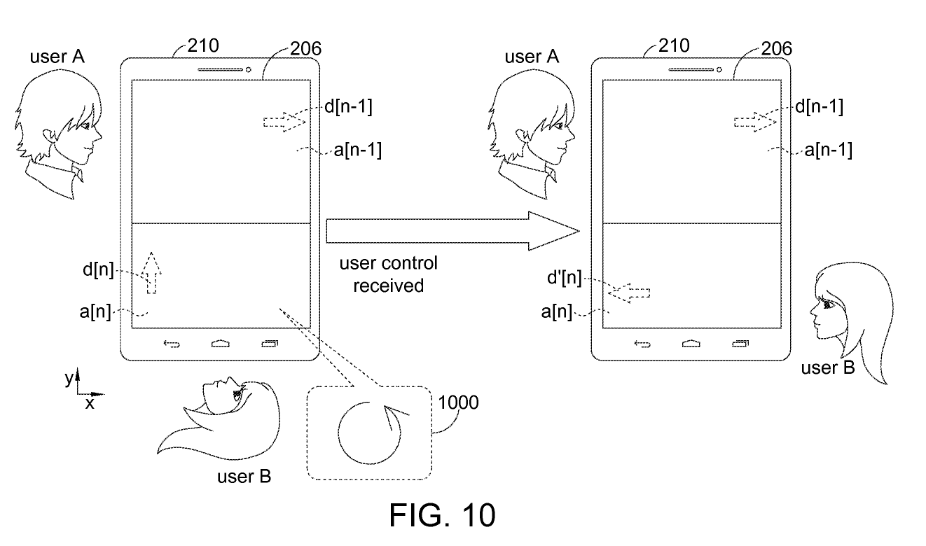

In the example shown in FIG. 10, the original directions d[n−1] and d[n] of the windows a[n−1] and a[n] may respectively point along positive x-axis and positive y-axis. When a gesture located in the window a[n] is sensed and compared to match an exemplary predetermined directing gesture 1000, the circuit 200 may execute the flowchart 100 to realign the window a[n] from the original direction d[n] to d′[n]. The exemplary directing gesture 1000 may reflect a counter-clockwise rotation of 90 degrees; accordingly, the layout determination module 204 may cause the updated direction d′[n] to point along negative x-axis, which is counter-clockwise 90-degree separated from positive y-axis. By such rotation, the user B originally at the bottom side of the device 210 may view the window a[n] from the right side of the device 210.

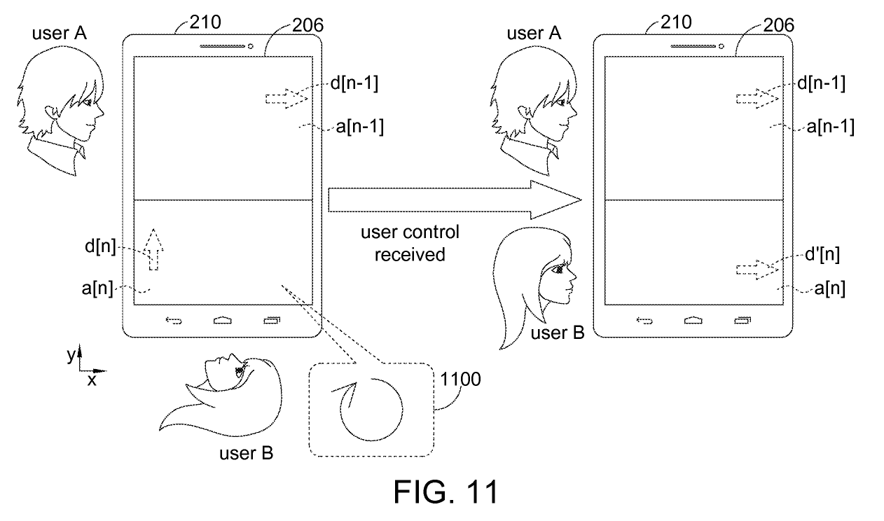

In the example shown in FIG. 11, the original directions d[n−1] and d[n] of the windows a[n−1] and a[n] may respectively point along positive x-axis and positive y-axis. When a gesture located in the window a[n] is sensed and compared to match an exemplary predetermined directing gesture 1100, the circuit 200 may execute the flowchart 100 to realign the window a[n] from the original direction d[n] to an updated direction d′[n]. The exemplary directing gesture 1100 may reflect a clockwise rotation of 90 degrees; in response, the layout determination module 204 may cause the updated direction d′[n] to point along positive x-axis, which is clockwise 90-degree separated from positive y-axis. By such rotation, the user B originally at the bottom side of the device 210 may view the window a[n] from the same side with the user A, while the direction d[n−1] of the window a[n−1] may independently remain unchanged.

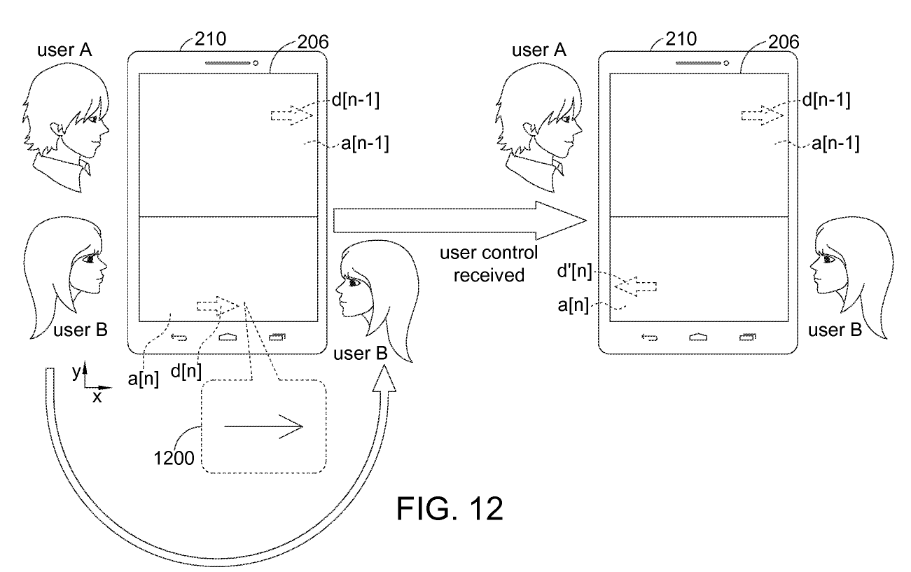

In the example shown in FIG. 12, the original directions d[n−1] and d[n] of the windows a[n−1] and a[n] may both point along positive x-axis. When a gesture located in the window a[n] is sensed and compared to match an exemplary predetermined directing gesture 1200, the circuit 200 may execute the flowchart 100 to realign the window a[n] from the original direction d[n] to an updated direction d′[n]. The exemplary directing gesture 1200 may reflect a direction toward the user; for example, the user B originally at the same side (e.g., left side) with the user A may move to a different side (e.g., right side) and use the directing gesture 1200 to notify a new desired direction; in response, the layout determination module 204 may cause the updated direction d′[n] to point opposite to the direction toward the user B, e.g., point along negative x-axis, since the direction toward the user B points along positive x-axis in the example of FIG. 12. By such arrangement, the user B originally at the left side of the device 210 may view the window a[n] from the right side of the device 210, while the direction d[n−1] of the window a[n−1] may independently remain unchanged.

The gestures for triggering direction notification are not limited to the exemplary gestures 900 to 1200 illustrated in FIG. 9 to FIG. 12; other directing gestures may also be utilized. For example, in the scenario shown in FIG. 12, as the user B moves from the left side to the right side of the device 210, the user B may double click somewhere, in the window a[n], near the side closest to the user B (e.g., the right side of the device 210), so as to indicate where a new bottom side of the window a[n] should be; in response, the layout determination module 204 may cause the updated direction d′[n] to point along the negative x-axis, and the bottom side of the window a[n] may therefore be relocated to the right side of the device 210.

In an embodiment, while the layout determination module 204 executes step 104 to align direction(s) of window(s) in response to direction notification, the layout determination module 204 may also adjust aspect of one or more windows if necessary, so the aspect of each window may keep satisfying the associated aspect condition of each window after direction realignment.

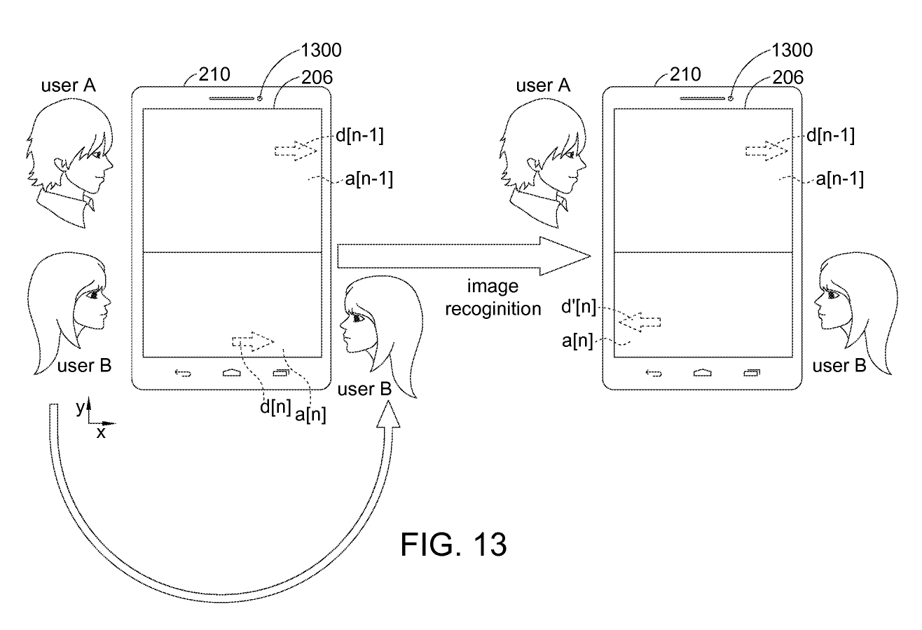

Following the embodiment in FIG. 1 and FIG. 2, please refer to FIG. 13 illustrating an automatic direction notification according to an embodiment of the invention. As shown in FIG. 13, the device 210 may further include a front camera 1300 capable of capturing images of users, so the device 210 or the circuit 200 may identify and track locations of users according to the images, for example, by image recognition (e.g., face recognition). When one or more users change location, the device 210 may automatically trigger a direct notification to start the flowchart 100 for direction realignment (and aspect adjustment, if necessary).

As shown in the example of FIG. 13, while windows a[n−1] and a[n] are displayed in the region 206 with directions d[n−1] and d[n] pointing along positive x-axis, a user B originally at a same side (e.g., the left side of the device 210) with a user A may move to lean on a different side (e.g., the right side of the device 210). By image recognition, the device 210 may sense that the user B near the window a[n] has changed location (e.g., to the right side of the device 210), and therefore trigger the flowchart 100 by a direction notification associated with the window a[n]. Accordingly, the layout determination module 204 may change the direction d[n] to an updated direction d′[n] (e.g., a direction pointing along negative x-axis) in step 104, so as to adapt the new location of the user B.

Though the exemplary layouts shown in FIG. 9 to FIG. 13 relate to two windows, the layout determination module 204 may arrange layout for more windows based on the principles demonstrated by FIG. 9 to FIG. 13.

To sum up, while prior arts merely arrange multiple windows by evenly spiting display region or overlapping windows of equal size in cascade, the prior arts fail to independently consider individual aspect and direction of each window. On the contrary, the invention may provide layout which may satisfy individual aspect requirement of each window, and/or align direction of each window independently regardless directions of other windows. Accordingly, the invention may therefore make more effective use of multiple windows, and hence improve user experience.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for arranging a window on a screen of a device, comprising:
identifying a layout information associated with the window, wherein the layout information comprises at least one of the following: an aspect condition and a direction notification; and
by the device, performing a layout determination for the window by at least one of the following:
causing an aspect of the window to satisfy the aspect condition; and
aligning a direction of the window according to the direction notification, independent of a direction of another window on the screen.

2. The method of claim 1, wherein the window is a second window to be displayed in a region after a first window is displayed in the region, and the method further comprises:
adjusting the first window to display the second window.

3. The method of claim 2 further comprising:
if the aspect condition of the second window requires a horizontal aspect with a height of the second window being shorter than a width of the second window, vertically stacking the first window and the second window.

4. The method of claim 3 further comprising:
if the first window is of a horizontal aspect with a height of the first window being shorter than a width of the first window, changing a direction of the region.

5. The method of claim 2 further comprising:
if the aspect condition of the second window requires a vertical aspect with a height of the second window being longer than a width of the second window, horizontally lining the first window and the second window.

6. The method of claim 5 further comprising:
if the first window is of a vertical aspect with a height of the first window being longer than a width of the first window, changing a direction of the region.

7. The method of claim 1, wherein the window is displayed in a region, and the method further comprises:
according to the aspect condition, identifying a longer dimension of the window from two perpendicular sides of the window; and
causing the longer dimension of the window to be perpendicular to a longer dimension of the region, with the longer dimension of the region being a longer one of two perpendicular sides of the region.

8. The method of claim 1 further comprising: in response to rotation of the region or an attempt to change size of the window, causing the aspect of the window to keep satisfying the aspect condition.

9. The method of claim 1, wherein the direction notification is triggered by user control.

10. The method of claim 1, wherein the direction notification is triggered by image recognition.

11. The method of claim 1, wherein the window is a second window displayed along with a first window, and aligning the direction of the second window causes the direction of the second window to differ from a direction of the first window.

12. A method for arranging a window on a screen of a device, comprising:
identifying an aspect condition associated with the window; and
by the device, performing a layout determination for the window by causing an aspect of the window to satisfy the aspect condition.

13. The method of claim 12, wherein the window is a second window to be displayed after a first window is displayed, and the method further comprises:
if the aspect condition of the second window requires a horizontal aspect with a height of the second window being shorter than a width of the second window, vertically stacking the first window and the second window.

14. The method of claim 13 further comprising:
if the first window is of a horizontal aspect with a height of the first window being shorter than a width of the first window, changing direction of the region.

15. The method of claim 13 further comprising:
if the aspect condition of the second window requires a vertical aspect with a height of the second window being longer than a width of the second window, horizontally lining the first window and the second window.

16. The method of claim 15 further comprising:
if the first window is of a vertical aspect with a height of the first window being longer than a width of the first window, changing direction of the region.

17. A circuit for arranging a window on a screen of a device, comprising:
a layout information module capable of identifying a layout information associated with the window, wherein the layout information comprises at least one of the following: an aspect condition and a direction notification; and
a layout determination module capable of performing a layout determination for the window by at least one of the following:
causing an aspect of the window to satisfy the aspect condition; and
aligning a direction of the window according to the direction notification, independent of a direction of another window on the screen.

18. The circuit of claim 17, wherein the window is a second window to be displayed after a first window is displayed, and the layout determination module is further capable of:
if the aspect condition of the second window requires a horizontal aspect with a height of the second window being shorter than a width of the second window, vertically stacking the first window and the second window.

19. The circuit of claim 17, wherein the window is a second window to be displayed after a first window is displayed, and the layout determination module is further capable of:
if the aspect condition of the second window requires a vertical aspect with a height of the second window being longer than a width of the second window, horizontally lining the first window and the second window.

20. The circuit of claim 17, wherein the window is a second window displayed along with a first window, and aligning the direction of the second window causes the direction of the second window to differ from a direction of the first window.
